(19) United States
(12) Patent Application Publication
(10) Pub. No.: US 2002/0180997 A1
(43) Pub. Date: Dec. 5, 2002

(54) Embedding color profiles in raster image data using data hiding techniques

(75) Inventor: William A. Rozzi, Stillwater, MN (US)

Correspondence Address: Attention: William D. Bauer, Imation Corp., Legal Affairs, P.O. Box 64898, St. Paul, MN, 55164-0898, US

(73) Assignee: Imation Corp.

(21) Appl. No.: 09/867,055

(22) Filed: May 29, 2001

(51) Int. Cl. B41J 1/00; G06F 15/00

(52) U.S. Cl. 358/1.9

(57) ABSTRACT

In one embodiment, raster image data of an image including pixel intensity, pixel color, or the like, can be varied slightly to encode color profile data within the image without significantly altering the visual appearance of the image. The encoded data may represent color profile data for a source device, and can be extracted by a destination device for use in performing color transformations for improved color image accuracy.

### FIELD

The invention relates to color imaging and, more particularly, to communication of color profile information.

### BACKGROUND

Color imaging devices use combinations of different device-dependent coordinates to form color images for display or printout on media such as paper or film. Many hardcopy printing devices use combinations of cyan, magenta, yellow, and black (CMYK) to form color imagery. These device-dependent coordinates of C, M, Y and K may be combined to form a gamut of colorimetric values that the device is capable of producing. Display devices, such as cathode ray tubes (CRTs) or flat panel monitors, may use the device-dependent coordinates of red, green, and blue (RGB). Some high-fidelity color imaging devices may use the device-dependent coordinates cyan, magenta, yellow, and black in combination with other coordinates such as orange and green. These and other device-dependent coordinate systems have been developed for use with various color imaging devices.

Many different device-independent coordinate systems have been developed in an attempt to standardize color specification across different devices. For instance, the Commission Internationale de l'Eclairage (CIE) has developed device-independent color spaces such as the L*a*b* color space (hereafter L*a*b* color space, L*a*b* space, or simply L*a*b*) and the XYZ color space (hereafter XYZ color space, XYZ space, or simply XYZ). Moreover, several other organizations and individuals have developed other device-independent colors spaces.

A point in a device-independent color space theoretically defines a color value irrespective of any particular device coordinates. A point in L*a*b* space or XYZ space, for instance, can be mapped to a point in a device gamut. That point in the device gamut, in turn, defines a combination of device colorants that will theoretically produce a color that is visually equivalent to that defined by the point in L*a*b* space or XYZ space. In reality, however, when device-independent coordinates are inputted into different devices, the output often looks different.

Color management tools and techniques have been developed to enable more accurate color matching between the output of different devices. For instance, color profiles and color matching modules (CMMs) have been developed for this purpose.

Color profiles, for instance, can be used to characterize and define the colorimetric characteristics of a device that was used to generate a particular color image. A color profile is a data structure that describes the color characteristics of a particular device. A color profile may include color information such as information describing the relationship between the device's device-dependent coordinates and device-independent coordinates. Moreover, the color profile may include information characterizing the print media used (in the case of a printer) or information categorizing the phosphors (in the case of a computer display). In addition, a color profile may even include information that characterizes illumination conditions at the time the image was rendered. This and other information may be included in a color profile.

Color matching modules (CMMs) are generally software applications that facilitate accurate color matching. A CMM may implement an algorithm, for instance, to match the color output between two different devices. Using respective color profiles as input, a CMM may alter the color data that is sent to a second device so that the output of the second device will be a more accurate visual match to that of the first device.

A CMM is generally loaded on a computer that controls the second device. Therefore, the CMM may be automatically provided with the color profile of the second device. When an image file is sent to the second device, for instance, an additional file may be sent with, or appended to the image file to provide the CMM with the color profile of the first device. In this manner, the CMM may obtain the input necessary to perform a color matching algorithm. Thus, the output of the second device can be adjusted to more accurately match the output of the first device.

In this document the term image refers broadly to any type of graphical rendering. For example, an image could simply be a page of text, a picture, a chart, or another pictorial device such as user interface elements like buttons or windows generated by a computer's operating system software. Generally, a graphical element or any collection of graphical elements can comprise an image.

### SUMMARY OF THE INVENTION

The invention involves methods, systems, and computer readable media carrying program code for embedding information describing color properties of an image or imaging device within raster image data of an image. In one embodiment, for example, a method may include obtaining information describing color properties of a device that generates an image, and embedding the information within raster image data associated with the image such that the embedded information does not substantially affect the visual appearance of the image to a user. The method may further include extracting the color profile from the image. In addition, the method may further include displaying or printing the image based on the color profile.

The information describing color properties may include a color profile such as a spectral profile and a colorimetric profile. Alternatively, the information describing color properties may include a path indicating a network location of a color profile for the image. For instance, the path may be an internet uniform resource locator (URL).

If the image includes a border, the information describing color properties may be embedded within the border. The method may further comprise creating a border for the image and embedding the information within raster image data of the border.

Additionally, the method may further comprise embedding an indicator within the image or attaching an indicator to the image. For instance, the indicator may indicate that information describing color properties of the image is stored within the image. In addition, the indicator may indicate where the information describing color properties of the image is stored within the image.

In another embodiment a method may include receiving an image file of an image, and extracting information describing color properties of the image from raster image data of the image file. Again, the information describing color properties of the image may include a color profile such as such as a spectral profile and a colorimetric profile. The method may further include displaying or printing the image based on the color profile.

The method may further comprise, prior to extracting embedded information, detecting embedded information. For instance, detecting embedded information may comprise detecting an indicator. The indicator, for example, may be embedded within the image or attached to the image.

In still another embodiment, an image file may include raster image data and information embedded within the raster image data describing color properties of the image. The embedded information may not substantially affect the visual appearance of the image to a user. If the image includes a border, the information embedded within the raster image data of the image may be embedded in the image border.

The information embedded within the raster image data may comprise a color profile such as a colorimetric profile or a spectral profile. The information embedded within the raster image data may alter the image. However, the alteration may not be perceivable to a human observer.

In other embodiments, the invention comprises a computer readable medium that carries program code that when executed performs one or more of the methods described above.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 is a flow diagram according to an embodiment of the invention.

FIG. 2 is a block diagram of a computer system that includes color management capabilities according to the invention.

FIG. 3 is another flow diagram according to an embodiment of the invention.

FIG. 4 illustrates an image with a created border.

FIG. 5 is yet another flow diagram according to an embodiment of the invention.

FIG. 6 is a block diagram of an image acquisition device according to the invention.

FIG. 7 is a block diagram of a system according to the invention.

### DETAILED DESCRIPTION

In general, the invention provides methods, apparatuses, systems, and computer readable media carrying program code for embedding information describing color properties of an image or imaging device within raster image data of an image. In one example, the information is a color profile. By embedding the color profile within the raster image data of an image, the color profile may become part of the image. In particular, the art of steganography, sometimes referred to as “data hiding,” can be used to encode color profile data into a file containing raster image data.

The ability to encode data within a data file has been extensively researched and developed. U.S. Pat. No. 5,850,481, 5,930,377, 6,072,888, 6,111,954, 6,122,392, 6,137,892, and the many references cited in those patents, for instance, describe in detail many different ways that information can be hidden within an image. Many data hiding applications have involved the production of “digital watermarks” as an anti-counterfeiting measure. The hidden data can be extracted from a data file and compared with reference data to determine whether a copy of an image, software application, or other digital work is authentic.

In accordance with the invention, raster image data including pixel intensity, pixel color, or the like, can be varied slightly to encode color profile data within the image without significantly altering the visual appearance of the image. The encoded data may represent color profile data for a source device, and can be extracted by a destination device for use in performing color transformations for improved color image accuracy.

A number of data hiding techniques may be useful for embedding color profile information. If raster image data is provided on a carrier wave, for example, raster image data can be varied by embedding additional signals on the carrier wave without significantly altering the visual appearance of the image. In many cases, to a human observer, the appearance of an image that includes embedded information will look visually equivalent to the same image that does not include embedded information.

Some techniques for encoding data within an image may have embedded data limits. For instance, if too much information is embedded within raster image data, the appearance of the image may be noticeably affected. However, as techniques and methods for data hiding continue to improve, the useful density of encoded data will also improve.

The amount of information that can be embedded in raster image data of an image file is generally a function of the size of the image file. Larger image files can store more embedded information than smaller files. In addition, the appearance of the image may affect the embedded data density. For instance, data may be more readily embedded in dark areas of an image. Also, image borders may provide a useful high-density location for storing embedded information.

For most steganographic applications, the embedded information has related to source identification information. For instance, as mentioned above, copyright or trademark information is often embedded within an image to identify the owner of the image. This can allow a copyright owner, for example, to identify images that have been used without his or her permission. Because the copyright information can be embedded in the raster data of the image in a way that is not perceivable by a human observer, a copyright infringer may be unaware that the image he or she has used without permission actually has the copyright owners “signature” in the image. Serial numbers or other identification words, for instance, are also traditionally embedded in an image.

Color imaging is another application that can benefit from the ability to encode data within raster image data, especially as data encoding densities improve. In particular, steganographic techniques can be used to embed color profile information within the color image to which the profile pertains. By encoding information indicative of a color profile, in accordance with the invention, there is no need to provide a separate file, header, or data structure for the color profile. Instead, the color profile information is interspersed with the raster image, providing a digital “watermark” that identifies not only the origin of an image, but the colorimetric characteristics about the device and environment involved in creating or modifying the image.

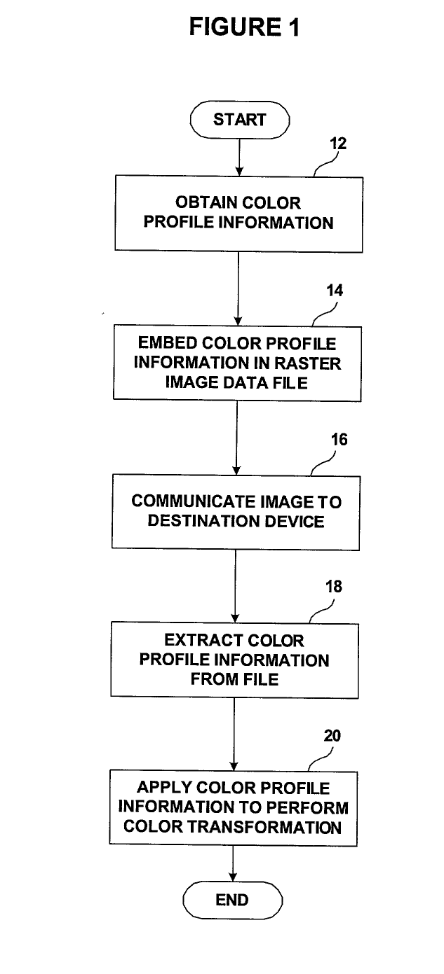

FIG. 1 is a flow diagram according to an embodiment of the invention. As shown, color profile information relating to an image may be provided (12). The information may then be embedded into raster image data file defining the image (14). Upon communicating the raster image data file to a destination device (16), the color profile information can be extracted (18) and applied by the destination device or a destination host computer to perform a color transformation of the raster image data (20). In this manner, color information relating to an image may become part of the image itself.

Embedding color profile information in the raster image data of an image file can realize several advantages. For instance, if a color profile is embedded in the raster image data of an image file, the color profile may always be associated with the image. If, on the other hand, the color profile were a separate file, the color profile could become lost or otherwise disassociated with the image.

In addition, embedding a color profile in the raster image data of an image file may reduce the number of files needed to render the image in an imaging process. If files are being communicated over a network, for example, reducing the number of files may reduce the amount of network bandwidth that is used in the imaging process. Moreover, reducing the number of files can reduce the time it takes to send image data over a network.

The color profile information may be a color profile of a first device, e.g., a source device such as a scanner, a digital camera, or another image acquisition device. For instance, if the first device is used to print or display the image, a color profile of that device may be provided. The color profile may define colorimetric or spectral characteristics of the first device, and may take the form of raw, parametric data or computed profile information. The color profile for the first device may then be embedded into raster image data of the image produced by the first device so that a CMM operating with a second device can extract the color profile of the first device from the image. In this manner, a CMM can have sufficient data to perform color transformation for improved color matching. This, in turn, can ensure that the second device prints or displays the image in a manner that is visually similar to the original print or display rendered by the first device.

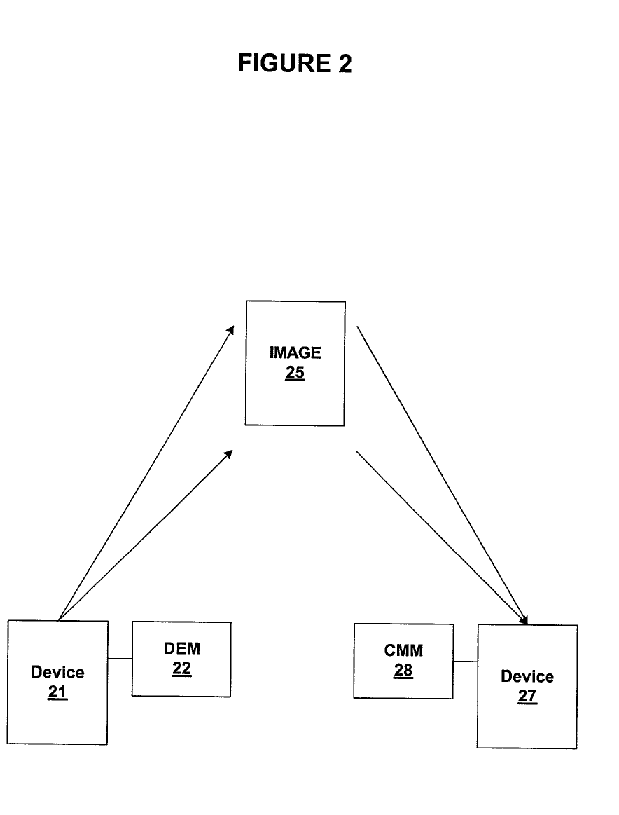

FIG. 2 is a block diagram of a computer system that includes color management capabilities according to the invention. As shown in FIG. 2, a first device 21 may include a data embedding module (DEM) 22. A second device 27 may include a CMM 28. DEM 22 may be a software program that can embed information into raster image data of a color image file 25 using any of a variety of steganographic techniques. First device 21 and second device 27 may take the form of printers, display devices, or other devices for acquiring or rendering color imagery. DEM 22 may run on a host computer associated with first device 21 or may be embedded within the hardware of the first device. For example, commercially available software packages relating to steganography, or even freeware could be used to realize DEM 22.

Similarly, CMM 28 may run on a host computer associated with second device 27 or may be embedded in hardware of the second device. The information embedded in image file 25, for instance, may include a color profile for first device 21. Thus, image 25 may include the color profile of the first device 21 within its raster image data. Moreover, the existence of the color profile within image file 25 can be imperceptible to an ordinary human observer.

CMM 28 may be software that operates with second device 27 to ensure that second device 27 renders accurate color, and may include or interact with a software module that extracts the color profile information from image file 25. The accuracy of color can be defined in terms of the original rendering of image 25. For instance, raster image data embedded with the color profile of the first device 21 can be received by second device 27. CMM 28 then detects and extracts the color profile of the first device 21 from the raster image data. CMM 28 may run a color matching algorithm using the color profile of the first device 21 that was extracted from the raster image data and a color profile characterizing the calorimetric or spectral characteristics of the second device 27. In this manner, CMM 28 can ensure that second device 27 outputs an image that is a more accurate visual match to image 25.

First and second devices 21, 27 may be display devices, printers, scanners, cameras or any other image-acquiring or image-rendering device. In one exemplary embodiment, for instance, first device 21 is a display device and second device 27 is a printer. CMM 28 and DEM 22, for instance, may be software loaded into first and second devices 21, 27, or alternatively may be software loaded into host computer devices (not shown) that respectively control first and second devices 21, 27. CMM 28 and DMM 22 can collectively ensure that the images displayed on first device 21 look visually similar to the images printed by second device 27.

As mentioned above, embedded data density limits may pose constraints on the ability to embed color profiles in raster image data. Indeed, depending on the amount of information provided, a color profile may include a significant amount of data. Although data density limits will continue to increase as data encoding technologies improve, current implementations of the invention may use additional techniques to ensure that a color profile is embedded within raster image data of an image. In other words, in some embodiments, the invention may apply techniques that provide for a more economic use of the hidden data capacity available within a given image. The hidden data capacity can be considered the maximum amount of data that can be encoded into the image data without introducing visually perceptible artifacts. In some embodiments, the color profile may be compressed so as to reduce the amount of data that is hidden. In that case, when the compressed data is extracted from the image file it would need to be decompressed.

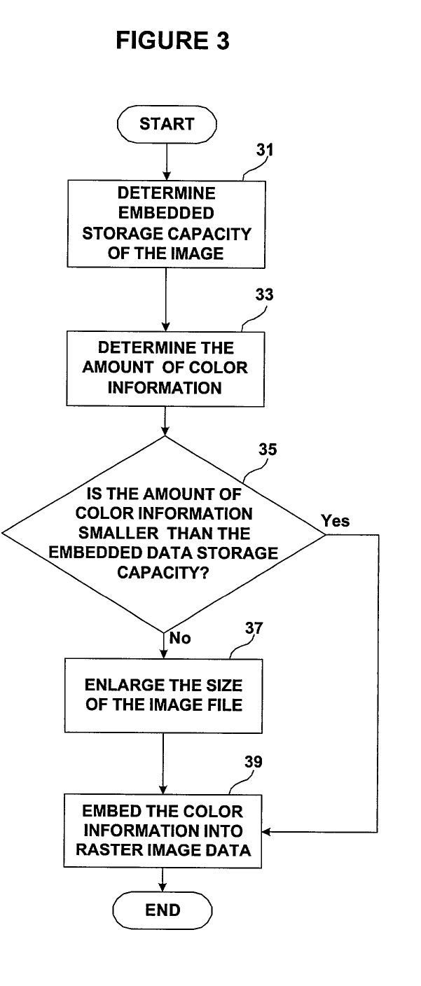

FIG. 3 is another flow diagram according to an embodiment of the invention. As shown, the embedded data storage capacity of the image is determined (31) and the amount of color information determined (33). If the amount of color information is smaller than the embedded data storage capacity of the image (yes branch of 35), then the color information may be embedded within the raster image data (39). However, if the amount of color information is larger than the embedded data storage capacity of the image, then the size of the image file may be increased (37) before the color information is embedded within the raster image data (39).

In one example, the image file is increased (37) by creating an image border on one or more sides of the image. The border becomes part of the image and increases the size of the image file. In addition, the border also increases the embedded data storage capacity. After the border has been created, it is part of the image file.

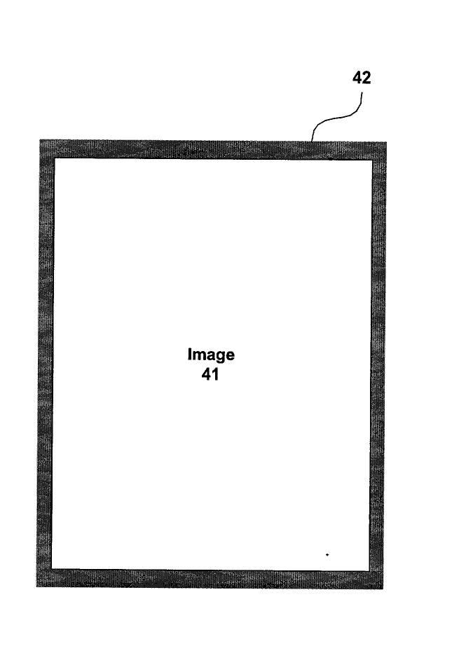

The raster image data defining the border may have an embedded data storage density that is higher than the than the rest of the image. Moreover, in some cases, a border can visually enhance the image, e.g., in the same way a picture frame enhances a picture. FIG. 4 illustrates an image 41 with a created border 43.

For example, each pixel in the border of an RGB image may be defined by three bytes of data.. Each byte may correspond to the intensity of one of the red, green, or blue channels for that pixel. The three least significant bits of the bytes that define each pixel of the border may be used to hide data without significantly affecting the visual appearance of the image. For this reason, the border provides a relatively high density area for storing embedded data.

In some implementations, a border is created whether or not the color information can fit within the raster image data without a border. The color information can be stored solely in the created border, rather than in the original image data and a newly created border. This can allow a CMM, for instance, to more easily locate and extract the color information.

Whether it is embedded in the raster image data of the original image, embedded in the created border, or embedded in a combination of the original image and the created border, the color information may include a color profile. Moreover, the color profile may include color information that corresponds to the device that first rendered the image or it may include color information that corresponds to the device that captured the image. The color profile may include a number of different device characteristics and may be a traditional color profile such as an ICC profile. An ICC profile is a calorimetric profile that conforms to existing specifications published by the International Color Consortium (ICC) for characterization of a particular device. Alternatively, the color profile may be a spectral or spectrally-based color profile.

In other embodiments, the color information includes a path to find the color profile. For instance, the path could simply be a number or character that corresponds to a lookup table. Alternatively, the path could be a network address, such as a local area network (LAN) pathname, an internet protocol (IP) address, or an internet uniform resource locator (URL) identifying an internet accessible color profile. A web server, for example, could include a large number of web pages, each of which corresponds to a particular color profile. Alternatively, each profile may not require its own web page; rather, the web server could simply serve a file to a destination device upon request. Either way, a path (e.g., a URL) could be embedded in that raster image data of an image, and a device that received that image could locate the color profile via the path. Destination device 27, for example could access the color profile based on the path information embedded in the raster image data.

In still other embodiments, the color information may include an indicator that can indicate what color information is embedded within the raster image data, where the information is embedded, or both. The color information may be inseparable from the image, meaning that it forms part of the image itself.

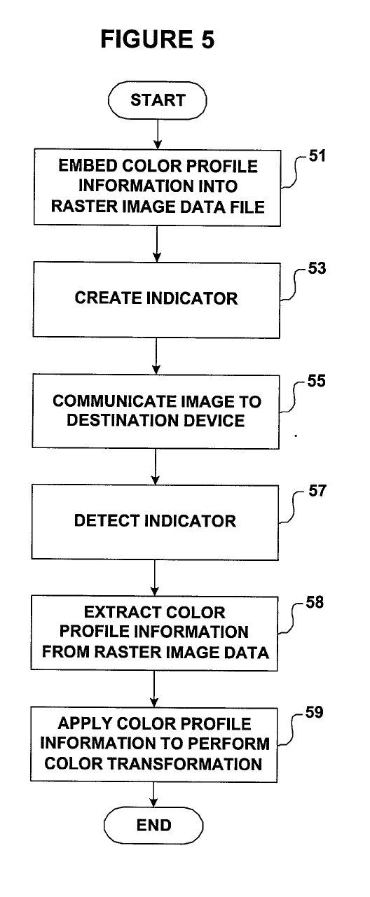

FIG. 5 is a flow diagram according to an embodiment of the invention. As shown, color profile information may be embedded into raster image data (51) and an indicator may be created (53). The indicator may also be embedded in the raster image data of the image. Alternatively, the indicator may be attached to the image, e.g., as a header or footer to the image file. If present, the indicator can be used to indicate whether color information is embedded in the raster image data of the image. Moreover, the indicator may indicate what information is embedded in the raster image data of the image, and/or where the information is embedded. For example, if color information is embedded in the raster image data of an image border, an indicator may be appended to the image file to indicate that fact.

When the image file is communicated to a destination device (55), the destination device may look for an indicator. If the device receives an image and detects an indicator (57), the device may locate and interpret the embedded information. In this manner, the device may be able to extract a color profile that is embedded in the raster image data of an image (58). Moreover, after detecting and extracting the color profile information, the destination device can then perform a color transformation (59).

Embedding color information in the raster image data of an image can realize several advantages. A color profile embedded in the raster image data of an image is actually part of the image itself. Therefore, any device that receives the image will also receive the color profile associated with that image. If, on the other hand, the color profile were a separate file, the color profile could become lost or otherwise disassociated with the image.

In addition, embedding the color profile within the raster image data can ensure that the color profile will not be inadvertently altered. If the profile were stored in a header or footer, for example, someone may be able to access the profile and alter it. However, if the profile is stored in the raster image data of the image, altering the profile may be more difficult. Consequently, image color quality can be better assured if a color profile is embedded in raster image data.

Moreover, as mentioned above, embedding a color profile in the raster image data of an image file may reduce the number of files needed to render the image in an imaging process. Again, if files are being communicated over a network, reducing the number of files may reduce the amount of network bandwidth that is used in the imaging process, and can also reduce the time it takes to send image data over a network.

Finally, embedding a color profile within raster image data of an image can be more efficient than other methods of storing a profile. For example, an image embedded within a color profile may be a smaller image file than an image file that includes the image and an attached header or footer.

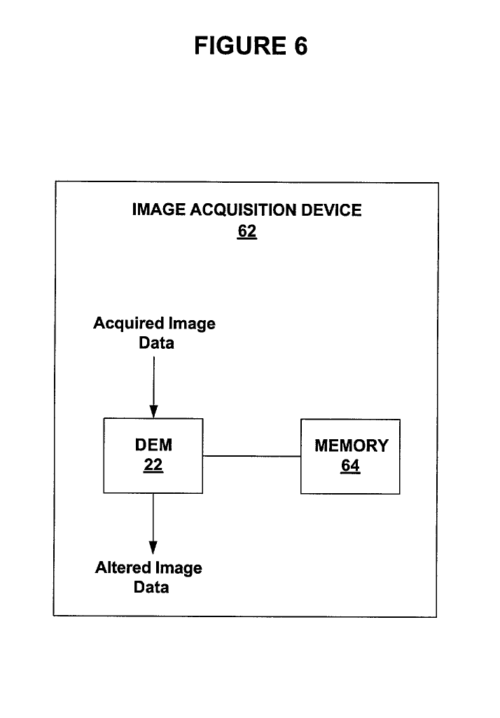

FIG. 6 is a block diagram of an image acquisition device according to the invention. For example, the device in FIG. 6 may be a digital camera, a scanner, or any other device capable of acquiring a digital representation of an image or scene. As shown, the acquired image data acquired by image acquisition device 62 can be inputted into DEM 22 internal to the device 62. Memory 64 can be used to store the color profile of device 62. The color profile of device 62 can be inputted into DEM 22, which embeds the color profile in the acquired image data. Altered image data having the color profile of device 62 embedded in the acquired image data can then be outputted from DEM 22.

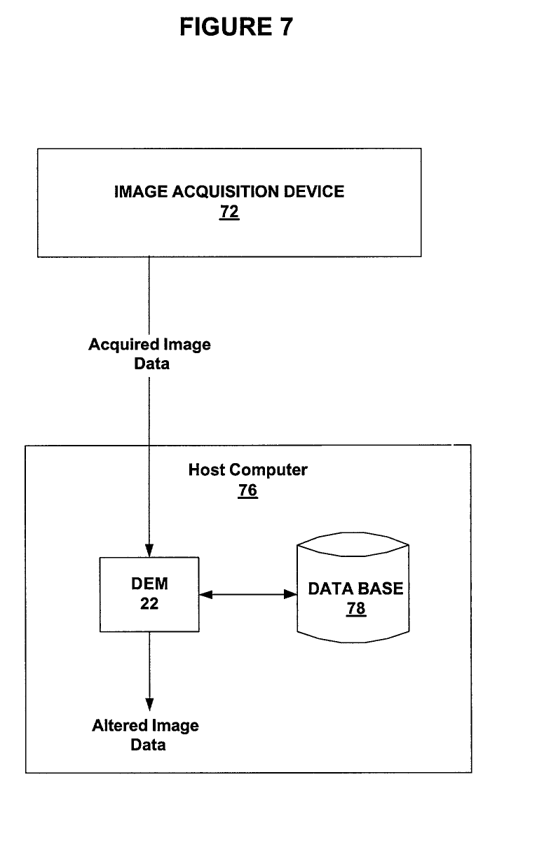

FIG. 7 is a block diagram illustrating a system including an image acquisition device 72 and a host computer 76. In this embodiment, the image acquisition device 72 such as a digital camera or a scanner, provides acquired image data to DEM 22 loaded on host computer 76. Data base 78 stores color profiles for various devices including a color profile for image acquisition device 72. Upon receiving acquired image data, DEM 22 retrieves the appropriate color profile from data base 78. For example, image acquisition device 72 may send additional information to host computer to identify itself, and then upon receiving the acquired image data DEM 22 can retrieve the color profile for image acquisition device 72 from data base 78. DEM 22 can then embed the retrieved color profile within the acquired image data. Altered image data having the color profile of device 72 embedded in the acquired image data can then be outputted from DEM 22.

The system may also include one or more processors, user input devices, display monitors, memory devices, storage devices, and printers. The system may substantially conform to conventional systems used by graphic artists and other users in the creation of textual and graphic imagery for electronic display or print reproduction. A memory/bus controller and system bus couple processor and memory, while one or more I/O controllers and I/O bus couple the processor and memory to image acquisition device 72, user input device, display monitor, storage device, and printer.

The program code for embedding or extracting color information from raster image data can be loaded into the memory from a storage device, which may take the form of a fixed hard drive or removable media drive associated with the system. For example, the program code can be initially carried on computer-readable media such as magnetic, optical, magneto-optic, phase-change, or other disk or tape media. Alternatively, the program code may be loaded into memory from electronic computer-readable media such as electrically-erasable-programmable-read-only-memory (EEPROM), or downloaded over a network connection. If downloaded, the program code may be initially embedded in a carrier wave or otherwise transmitted on an electromagnetic signal. The program code may be embodied as a feature in an application program providing a wide range of functionality.

A number of implementations of the present invention have been described. For instance, methods of storing color information as part of the raster image data of an image have been described. Nevertheless, it will be understood that various modifications may be made without departing from the spirit and scope of the invention. For instance, rather than a color profile, the color information could be any type of information used to facilitate accurate color rendering. These and other modifications can be made to the description above. Accordingly, other implementations and embodiments are within the scope of the following claims.

1. A method comprising:
obtaining information describing color properties of a device that generates an image; and
embedding the information within raster image data associated with the image such that the embedded information does not substantially affect the visual appearance of the image to a user.

2. The method of claim 1, wherein the information includes a color profile.

3. The method of claim 2, wherein the color profile is one of the following:
a spectral profile and a calorimetric profile.

4. The method of claim 2, further comprising extracting the color profile from the image.

5. The method of claim 4, further comprising modifying the image based on the color profile, and displaying the modified image.

6. The method of claim 4, further comprising modifying the image based on the color profile, and printing the modified image.

7. The method of claim 1, wherein the information describing color properties includes a path indicating a network location of a color profile for the image.

8. The method of claim 7, wherein the path is an internet uniform resource locator.

9. The method of claim 1, wherein the image includes a border, and wherein embedding information includes embedding the information within the border.

10. The method of claim 1, further comprising embedding an indicator within the image, the indicator indicating that information describing color properties of the image is stored within the image.

11. The method of claim 1, further comprising embedding an indicator within the image, the indicator identifying where the information describing color properties of the image is stored within the image.

12. The method of claim 1, further comprising attaching an indicator to the image, the indicator indicating that information describing color properties of the image is stored within the image.

13. The method of claim 1, further comprising creating a border for the image and embedding the information within raster image data of the border.

14. A method comprising:
receiving an image file of an image; and
extracting information describing color properties of the image from raster image data of the image file.

15. The method of claim 14, wherein the information describing color properties of the image includes a color profile.

16. The method of claim 15, wherein the color profile is one of a spectral profile and a colorimetric profile.

17. The method of claim 15, further comprising displaying the image according to the color profile.

18. The method of claim 15, further comprising printing the image according to the color profile.

19. The method of claim 14 wherein the information describing color properties includes a path to find a color profile for the image.

20. The method of claim 19, wherein the path is an internet uniform resource locator.

21. The method of claim 14, further comprising, prior to extracting embedded information, detecting embedded information.

22. The method of claim 21, wherein detecting embedded information comprises detecting an indicator.

23. The method of claim 22, wherein detecting the indicator comprises detecting the indicator embedded within the image.

24. The method of claim 22, wherein detecting the indicator comprises detecting the indicator attached to the image.

25. An image file comprising:
raster image data; and
information embedded within the raster image data describing color properties of the image, such that the embedded information does not substantially affect the visual appearance of the image to a user.

26. The image of claim 25, wherein the information embedded within the raster image data comprises a color profile.

27. The image of claim 25, wherein the information embedded within the raster image data alters the image.

28. The image of claim 27, wherein the alteration is not perceivable to a human observer.

29. The image of claim 25, wherein the image includes a border and the information embedded within the raster image data is embedded in the border.

30. A computer readable medium carrying program code that upon execution:
embeds information describing color properties of a device within raster image data associated with an image such that the embedded information does not substantially affect the visual appearance of the image to a user.

31. The computer readable medium of claim 30 further carrying program code that upon execution:
extracts the information from the image.

32. The computer readable medium of claim 31 further carrying program code that upon execution:
modifies the image based on the information.

33. The computer readable medium of claim 30 further carrying program code that upon execution:
embeds an indicator within the image.

34. The computer readable medium of claim 30 further carrying program code that upon execution:
attaches an indicator to the image.

35. The computer readable medium of claim 30 further carrying program code that upon execution:
creates a border for the image and embeds the information within raster image data of the border.

36. A computer readable medium carrying program code that upon execution:
extracts information describing color properties of the image from raster image data of the image file.

37. The computer readable medium of claim 36 further carrying program code that upon execution:
detects embedded information describing color properties of the image.

38. The computer readable medium of claim 36 further carrying program code that upon execution:
modifies the image based on the information.

39. An image acquisition device comprising:
memory that stores a color profile of the device; and
a data embedding module that embeds the color profile in image data acquired by the device.

40. The image acquisition device of claim 39, wherein the device is a scanner.

41. The image acquisition device of claim 39, wherein the device is a digital camera.

42. A system comprising:
an image acquisition device; and
a host computer coupled to the image acquisition device; the host computer including a memory device that stores a color profile of the image acquisition device and a data embedding module that embeds the color profile in image data acquired by the image acquisition device.
